(19) United States
(12) Patent Application Publication
(10) Pub. No.: US 2022/0180050 A1
(43) Pub. Date: Jun. 9, 2022

(54) Systems and Methods for Facilitating the Generation and Publishing of Personal Social Media

(71) Applicants: Rolando Rabines, Topsfield, MA (US); Roberto Mario Rabines, Topsfield, MA (US); Randall Marvin Anderson, Bedford, NH (US); Rolando Harlo Rabines, Topsfield, MA (US)

(72) Inventors: Rolando Rabines, Topsfield, MA (US); Roberto Mario Rabines, Topsfield, MA (US); Randall Marvin Anderson, Bedford, NH (US); Rolando Harlo Rabines, Topsfield, MA (US)

(21) Appl. No.: 17/112,215

(22) Filed: Dec. 4, 2020

Related U.S. Application Data
(60) Provisional application No. 62/944,133, filed on Dec. 5, 2019.

(51) Int. Cl. G06F 40/186; G06F 3/0482

(52) U.S. Cl. CPC G06F 40/186; G06F 3/0482

(57) ABSTRACT

Systems and methods for providing tools that a user can access to generate media content that can be published to the Internet. The system may include a processor for monitoring for input from the user and for selecting a template that includes a framework of the computer code needed to create displayable media content. The processor can apply the template to generate code that can be published to the Internet. The content generated by the user through this tool can be published to a data feed associated with an account held by the user. To this end, the user data feed will comprise personally generated and published content from the user. Additionally, the content published by the user to the user data feed will be curated by a network processor that will amend the content of the user media based on a computer model representing a network of relationships associated with the user. The network processor will then monitor real-world activity by people and other entities in that network of relationships to generate and transmit personal responses for the user so as to facilitate a meaningful exchange under all circumstances. In this way the system guarantees a user will receive a personally meaningful response every time a user generates and publishes personal content on the system. By making it easier for users to generate personally meaningful content, and by providing meaningful responses, the system can increase the levels of participation in content creation on social media platforms.

### CROSS-REFERENCE TO RELATED APPLICATIONS

This Patent application claims priority to U.S. Provisional Patent Application No. 62/944,133 filed Dec. 5, 2019 entitled “SYSTEMS AND METHODS FOR FACILITATING THE GENERATION AND PUBLISHING OF PERSONAL SOCIAL MEDIA” and assigned to the assignee hereof. The disclosure of the prior Application is considered part of and is incorporated by reference in this Patent Application.

### TECHNICAL FIELD

The systems and methods described herein generate and publish content, and in particular generate and publish personal content using a social media platform.

### BACKGROUND

Significant research has established that socializing is important for a healthy and productive society. Today, people are moving more and more to having actual relationships mediated by social media apps (the term app will be understood to mean an “application”—that is a computer process that carries out a function, and the term app and application will sometimes be used interchangeably herein). However, actually engaging through social media apps can be difficult. It is especially difficult for a user to generate personal content, and that is problematic as generating content that conveys his or her personal thoughts and feelings is essential to establishing meaningful connections with other users, and sharing personal thoughts and feelings is necessary for a user to engage with and make a social connection to another user. However, it remains today that the burden of generating personal content to make a social connection is often quite high.

Studies show that in large online communities 90% of the content is generated by about 10% of the users. See https://www.higherlogic.com/blog/90-9-1-rule-online-community-engagement-data (Heather McNair June 2020); and https://stangarfield.medium.com/90-9-1-rule-of-thumb-fact-or-fiction-2377c12f3a79 (Stan Garfield April 2018; originally published September 2016). These numbers can vary based on the size of the community using the social media application and as to how one defines “developing content”, but in general this is a useful metric. Using current social media applications, including Twitter, Instagram and Facebook, generating truly personal content that is relevant to other users and socially acceptable is a burdensome and awkward process. Even with the help of the smartphone camera to create new personal media, Instagram posts remain laborious to create and Twitter tweets are written and rewritten before posting. Once the novelty of the sending photos without context wears off, users must invest a lot of effort to create personal content worth sharing. Given this, it is no surprise that most content on social media applications is generated by small fraction of users.

But, generating and communicating socially relevant personal content is required for the kind of meaningful social connection these social media applications promise.

To address this issue, social media apps increasingly provide tools for users to take photographs and videos and add short captions so that they can use these to quickly generate personal content they can share, as well as mechanisms for other users to “like” this content with a simple tap at the user interface. These mechanisms help some users generate and react to content. Sometimes, these quick posts and “likes” may be perceived by other users as personal statements of the author, but even then, these “statements” are very limited in content, often seem robotic and offer little actual engagement between the author and the other users. For exchanges to be perceived as authentic and personal, they require a level of effort that most people are unwilling to invest, as well as authoring skills that few people possess.

Engineers and computer scientists have tried to make the development of social media content easier for users. One such example is set out in U.S. Pat. No. 10,771,513 entitled Multi-user Content Presentation System which discloses allowing a user to use simple hand motions to create and modify content suitable for posting on a social media application. However, these systems are more oriented toward collaboratively developing presentations by a group and having that presentation available on the social media application. Thus, the problem of helping a user generate initial content, or develop the collaboration in the first place, still remains.

Social media technology developers have also made it possible for users to react to content using emojis or other symbols But providing these symbols has failed to increase the levels of content creation. These failures further demonstrate that facilitating the generation of personal content on social media requires more than just providing mechanisms that help users generate more content with less effort. Users want connections that are social, and these require the exchange of meaningful content between counterparties, rather than simple pre-packaged and impersonal acknowledgements, such as emojis, that signal the desire to terminate the exchange rather than foster further engagement.

In U.S. Pat. No. 9,774,693 computer scientists have developed and disclosed technologies to make it easier for a user to track and view user-feedback to the posts the user created, and thus see feedback more easily so that the social aspect of receiving comments on a post are more readily experienced. The feedback can be comments, emojis and activations of like or dislike indicators. In all cases, the initial user still must generate the initial content that starts the conversation that generates feedback.

In U.S. Pat. No. 10,742,435 a system is disclosed that proactively provides content to participants of group chats. The system is an automated assistant that analyzes the content of a message exchange thread involving the participants. The automated assistant identifies a topic pertinent to the message exchange thread, and selects new content based both on the topic and the shared interests of the participants and proactively provides the new content to the participants. Although such systems can work well to create new content for person to receive, as noted above, such automatically generated content may be pertinent to the topic, but it lacks the authenticity of personal content developed by a human participant, and in fact is not content from a human participant. More importantly, it remains the burden of each user to react to the system prompt with personal original content, and to follow-up with relevant content to continue the conversation, so the problem of facilitating social exchanges remains.

Therefore, there is a need for improved systems for allowing users to generate and exchange personally meaningful content for social media platforms; this need arises for many reasons, some of which include that social media applications are used by a broad demographic and portions of that demographic find it technically challenging to create content that will be recognized by others as personally authentic. Additionally, many in that demographic find generating personally meaningful content to be socially daunting as they are not sure what to say on a public forum or even a private forum given their understanding that any content they generate will likely endure and can be copied and possibly distributed to others. Critically, equally daunting is the prospect that sharing their personal content will not lead to the meaningful exchange they seek, and that they will get no response in return.

### SUMMARY OF THE EMBODIMENTS

The systems, methods and devices of this disclosure each have several innovative aspects, no single one of which is solely responsible for the desirable attributes disclosed herein.

In one embodiment, the systems and methods described herein provide tools that a user can access to generate media content that can be published to the Internet. In one aspect, the systems and methods described herein aid a first user with developing entertaining social media posts that are edited to attract response messages from other users and such systems and methods which will automatically develop response messages for the first user for any post made by the first user. The systems may include a publisher processor that will identify patterns within a data set related to a domain. For example, the data may be a database of sports data. The publisher processor may apply machine learning processes to identify patterns within the data, where these patterns have been associated with themes suggesting one of two possible outcomes. For example, the publisher processor may identify a pattern suggesting a player is currently scoring well above his historic average and will identify that in the next game, this elevated level of play may or may not continue. The publisher processor will publish the Storyline to a news feed that is accessible by the system users. The published Storylines pose questions to the users and are formatted with a user interface that has a user-selectable switch that allows a user to input an answer to the question posed. The system formats that user input into a posting that can be published to the user's data feed to present the user's view on the question posed. To this end, the system may detect a signal representative of a choice selection by the user using the user-selectable switch. The system may then select a template that has a format for media content and may generate computer code for directing the creation of a computer readable media message capable of displaying the user's choice selection. The system may have a second processor for interpreting the computer readable media message to publish the media message as machine displayable content appearing as part of the user's data feed and publish the media message as a posting of the user's input and therefore the user's personal point of view about the question posed by the Storyline. Thus, in certain embodiments, the system aids the user with developing entertaining social media posts by editing the content associated with a Storyline and the user input to generate content targeted to attract response messages from other users.

Additionally, and optionally, the system will employ a template that allows the system, using a network processor, to curate the media message published by the user to the user data feed. The network processor may alter the content of the user media message based on a computer model representing a network of relationships associated with the user. The network processor monitors real-world activity by people and other entities (players, teams, leagues and associates of the user) in that network of relationships. The network processor alters the user media message to present on the user's data feed media messages that include responses to the user's media message. Thus, the systems achieve an objective of facilitating a meaningful exchange between the user and another party associated with the content of the user's media message. In this way the system operates to have a user receive a personally meaningful response message to each a user generated media message. By making it easier for users to generate personally meaningful content, and by operating to have meaningful responses to that content, the system can increase the level of content creation on social media platforms.

In one aspect, the systems and methods described herein provide a tool that a user can employ to generate media content that can be published to the Internet. Such tools as described herein allow a user who does not know the required technical procedures, or lacks the time, to facilely generate media content that can be published to the Internet and presented by the user as content that was personally created by that user.

In one embodiment, the systems described herein include a publisher processor that publishes content posts to a population of users. Each content post includes a question and two choices as answers to the question. In preferred embodiments, the question refers to a future outcome that cannot be known at the time, but that will be resolved with clarity in the near future such that the correct answer will be known and can be verified unambiguously. The content post includes a user interface that presents a user-selectable switch for allowing a user within the population of users to select one of the two choices. Once a user selects and answer, the post is cloned and the clone is claimed by that user. The cloned post is modified to create a user media message that provides the user's view point on the question posed in the storyline. From that point, a derivative storyline is created for the cloned post and associated with that user. In one aspect, the user's answer becomes an integral part of the storyline of the user's post.

In one embodiment, a first processor monitors the user-selectable switch to detect a signal representative of a choice selection by the user. The first processor selects a template representing a format for media content and generates, in response to the choice selection and to the content post from the system, computer code for directing the creation of a computer readable media message capable of displaying the choice selection and having the format associated with the template. A second processor interprets the computer readable media message to publish the media message as machine displayable content appearing as part of the data feed published within the account associated with the user. As a user answers more questions, the systems described herein builds out a data feed for that user's account that displays content generated from the user's input. In this way, the systems described herein allow the user to enter input and will generate the code to present that user input as posts of user generated content in the user's data feed.

In certain embodiments aspect, the systems described employ a user interface with simple mechanics, such as finger-swipes, as the user-selectable switch that allows a user to generate and publish personal content to the application. For example, the user may be presented with a question that can be answered, by a finger-swipe, either “yes” or “no”. The systems described herein can use the finger-swipe to generate content in a form that complies with the technical publication requirements of the social media publication protocol. Typically, this just requires formatting the content into a HTML, or a similar or related format that is compliant with the requirements for publication by the application. To this end, in some examples the systems use a template answer that includes relevant content for the context of the question. The system incorporates into the template, the user's finger-swipe response. The system publishes the created content as the user's personal and original content. The formatted content is published as a “Take”, which is a user's reaction, and typically a user reaction to a Storyline published over the application. A Storyline is a newsworthy posting, automatically generated and published on the application. Typically, a Storyline will contain news and report details about an event, such as an upcoming game (i.e., which teams, what date and time), details about the recent actions and performance of real-world protagonists (i.e. specific players' or teams' recent game stats), an editorial assessment regarding the meaning or significance of their recent record or upcoming game (i.e. it may assess a notable outcome in the last matchup), as well as a premise that defines a line of success (or failure) by the featured protagonists in a proximal event (i.e. above or below average performance for specific teams or players, in the next scheduled game). Users can easily react to any Storyline, and their reactions are automatically shared with other users on the application.

In preferred embodiments, each Storyline posted includes a question and two choices as answers to the question. For Storylines with a single protagonist the editorial success line will define the two choices for the question. For Storylines with two protagonists, the choices are each of the two protagonists. As discussed more below, the systems described herein will build the user's choice into a media message that expresses that choice and publishes the media message to the user's data feed for others to see. Other users will perceive the user's reaction as that user's personal Take (their personal thoughts and/or feelings) about the event and the protagonists, and can choose to generate and publish their own views, which in turn are automatically shared with others. This exchange of thoughts or feelings between two users is a mutual exchange of ideas and emotions, and provides a more meaningful and personal connection than merely viewing trivial photos of dinner plates or forwarded content produced by strangers. The content exchanged is perceived as authentic because it expresses a personal point of view about the success or failure of a protagonist that both parties (the user posting and the user seeing the post) care about, but moreover, the content is argument-worthy because the protagonist performance is framed in the context of a future event with an uncertain outcome. Unlike current content generation mechanisms available for social media, the systems described herein generate personally meaningful content that is designed to trigger additional follow-on personal content, by establishing personal stakes between users relative to each other, and relative to the performances of Storyline protagonists they care about. The systems then track these stakes in real-time and through event resolution, and they automatically generate additional original and personal content by scanning for notable patterns in the relationships established by each user across multiple Storylines with several protagonists and other users.

A Take, in some embodiments, may be understood as a user's opinion on a topic, where that topic is typically some newsworthy event. A Take may present the user's opinion, which is the user's reaction or view on a certain Storyline. Typically, a Storyline proposes an issue, sometimes in the form of a question that has two possible answers. The user of the app may express his or her reaction by selecting one of the two possible answers, essentially stating “where he/she stands” with respect to the issue in question, such as the performance of a specific team or player in an upcoming game. Takes, in certain embodiments, are a user's reaction, whether that reaction is logical, emotional or some of each, to the issue presented in the Storyline. In this way, Takes allow a user to express a personal view and convey that view. By doing so, the user becomes part of the story set out in the Storyline. The story in the Storyline evolves and, for example, may no longer be just a story about, for example, what Larry Bird did in the game, but about where that user was with respect to Mr. Bird's performance, and where other users, typically his/her friends, stand with respect to Mr. Bird's performance, and with respect to that user's opinions or feelings about Mr. Bird's performance. That reckoning, for example about which members of a friend group were on the “right side” with regard to Larry Bird's performance, regardless of whether Mr. Bird was successful or unsuccessful, becomes a story about the user and his/her friends as much as about Mr. Bird. Thus, the systems and methods described herein make it possible for people to become protagonists in numerous “game day” Storylines, alongside their friends and heroes, and to generate personally authentic content that shares those stories in a social media platform, with a frequency, quality and volume currently beyond their reach.

The systems described herein determine that there is a newsworthy, or comment worthy event related to topic of shared interest to a large community of users. In one example relevant to apps that focus on the domain of high school Sports, an event is Newsworthy and worth posting in a Storyline, if a discussion about the event is (i) timely (current, about upcoming games, such as the user's upcoming High School Thanksgiving day football game), (ii) significant (the performance of teams and players that are the subject of the stories that the app publishes are important to people that follow the sport), (iii) has proximity (users, typically while setting up a user profile, will note their favorite sports, teams, etc., so the Storylines that the app publishes for a user's personalized feed, are prioritized based on the subjects that are “proximate” to that user as specified in the user profile, (iv) prominence (stories are about well-known leagues, teams and players), and (v) human interest (people care about the subjects of their stories—many fans feel they have a relationship with their favorite teams and player—this para-social relationship feels as real as their relationships with friends and acquaintances). For example, in the domain of major league sports, the system may determine that a particular NBA basketball player is on a scoring streak of scoring more than 25 points per game. The system may also determine that this pace is statistically exceptional, especially for this player, being, for example, two or three standard deviations above relevant means. The system may process this statistical data into a succinct question, such as will player X's streak of scoring more than 25 points per game continue in tonight's game? In another example related to finance, the system may determine that the stock price of a certain company is a standard deviation above relevant means for price to earnings ratios, and formulate the question whether the price will regress to the mean over the next two weeks. In either example, the noteworthy pattern becomes the basis for generation a new posting on the app, while historical data about the topic is used to generate an argument-worthy premise that is included in the posting. Other relevant information is included in the posting and may be published based on a priority determined by the user preferences. These prioritization and filtering mechanisms achieve the objective that the Storylines the user choses to react to are personally interesting. The user as well as others that view the media messages (i.e. content) generated by the user's reaction to the Storyline are unlikely to perceive that content as authentic and personal without a high affinity to the topic and the protagonists.

Preferably, the Storyline posting is formatted to facilitate quick reaction from users, and any reactions become part of the post, increasing its priority for users that are connected through personal social graphs maintained by the application. The application also allows one user to transmit selected postings to another user directly through an integrated in-application chat/Direct Messaging channel. Optionally, the posting may be formatted to allow the receiving user to react to the posting with the same simple swipe gesture or other user-selectable switch, used in the primary posting channel (feed). Those reactions are similarly shared with others who the user is connected with through his or her social graph, and used by the system in follow-on content generation when scanning for notable patterns in these reactions.

To this end, certain embodiments of the systems and methods described herein will include systems and methods that scan large amounts of data about a certain topic, looking for noteworthy patterns of performance by a range of protagonists, and then matches pools of notable performances with information about upcoming events that involve any relevant protagonists from the pool. Unlike traditional manually-intensive publishing methods, the application need not be influenced by the popularity of a protagonist, or limited by the number of reporters or writers on staff. The systems described herein may consider and analyze the performances for the full universe of protagonists currently active in a topic. For example, when publishing stories about a professional sports league, the system can consider all teams and all players equally, and uncover patterns that would be practically impossible to detect using traditional research and publishing methods. Additionally, postings published are formatted to include a premise that defines opposing sides for performance by a protagonist in an upcoming event, and to make it easy for users to react and take a side based on their personal points of view. A large and diverse volume of postings by the application increases the likelihood that each user in a small circle of friends will be react to a posting that the others in that circle have not seen yet. Moreover, the system automatically propagates the sided reaction by one first user to other users that the first user is connected with via a social graph that the system generates based on user preferences and based on existing relationships among protagonists within a given topic. The social graph can represent a network of relationships, wherein a relationship is representative of an association between the first user and a second user of the system and wherein the association is determined based on monitoring the choices selected by the user.

Certain embodiments of the systems and methods described herein will include systems and methods that allow the application to also serve as a personalized story tracker to help manage a high volume of Storylines and Takes. For example, for a given sports league in season, the application can keep track of every Take by date and by game, so the user can easily navigate and stay on top of hundreds of active Storylines at the same time and in real-time. The systems and methods described herein improve publishing volume and speed about a topic, as well as increase the ease of content production by each user, thereby increasing the percentage of users that publish on an app, and provide a user with a tool for participating in on-going discussions as a contributor of original personal content, thus further increasing engagement within a community.

In one particular embodiment, the systems and methods described herein include a domain specific social media application, such as a social media application that curates sports content and exchanges of reactions and commentary about sports content among members of the on-line community. In one example, a social media application that curates sports content allows users to express easily a clear point of view on a topic. For example, a social media application of the type described herein will post stories that embed premises that may prompt users, or some users, of the application, for a prediction about an upcoming game, presenting the prompt in a format that users can either agree-with or disagree-with. A user can make a simple motion, such as a screen swipe, to indicate whether the user agrees or disagrees. The systems and methods described herein respond to the user reaction to the prompt and apply a template to enhance the post with the users Take on that game, so that it can be published on the social media application as user-generated content. Additionally, the system automatically creates personal highlights and dynamic stories in each user social media profile by analyzing the reactions of each user looking for notable patterns. Social media apps usually include a Profile section that stores and provides to the app those personal details that each user chooses to expose to other users on the same social network. Many of the connections on social media are not close relationships. Studies show that some users assert having thousands of followers, while a closer look reveals that the vast majority of those follower are persons which they have never met in person. Frequently, social media users will note a comment and look up the author's Profile. If the Profile is interesting, he or she may decide to establish a “following relationship” (that is “follow the author”) with the author so they can be notified of any future postings or comments by that same author. The system looks for meaningful patterns in the user reactions and automatically generates new content that highlights these patterns, and posts these highlights in that user's Profile. These highlights provide other users with personal details about a user that they can use to decide if they want to establish a following relationship. Importantly, these highlights can also be used by other users that already follow this user and have a close relationship to facilitate more meaningful connections and exchanges around aggregate patterns produced when combining several reactions to individual Storylines over time. Specifically, the meaning that can be extracted when a user reacts to a single Storyline about the Celtics team can be combined with meaning of other reactions to Celtic stories. For example, the system can detect patterns that highlight a user preference for a certain player or team based on his reactions without the user declaring his preference explicitly.

In another example, the system may also keep track of some or all of a user's indications, that is the user's “Takes”, as well as the Takes of the user's friends, and the system alerts the user if any of the user's friends back or challenge that user's Takes. The system may also notify the relevant users of the final outcome so that all can learn how they fared.

In another aspect, the systems and methods described herein provide an online sports media publisher that generates personal content that a user can publish, such as publishing to a data feed on a social media platform. To this end, the system may include an “App” (an application) that acts as a specialized media publisher, much like newspapers, blogs, and television broadcast dedicated to one topic of interest to a large community, such as a professional sports league like the NBA. The App generates or publishes Storylines about “newsworthy events” in that topic. In the sports topic, newsworthy events may be any event that could be of interest to the persons interested in sports, whether as entertainment, business or otherwise. For example, the time of a particular upcoming baseball game may be a newsworthy event, or the names of the starting pitchers set for the game could be a newsworthy event. The system may have algorithms and human curators that examine and analyze recent performance of sports teams, like the Yankees, and players, such as Aaron Judge, and look for “Storylines” that setup an interesting plot point, such as whether a hitting streak of Aaron Judge will continue in the upcoming game in which he is playing. Both the historical events that combined to shape the Storyline that the system uncovered and the upcoming performance that will move the plot along are “newsworthy events”. Also, in certain examples the Storylines are designed to communicate and provide two opinions. The two opinions are (a) whether a specific set/sequence of Team or Player historical events mean something, such as whether there is a streak, a bad or poorly played last game, or breakout performance (these editorial opinions may be based on human-curator judgements or on machine-learning algorithms that find patterns of performance that are out of the ordinary (and can be used to anchor the Storylines), and (b) whether the specific level of performance in the next game for this Team or Player would be a good basis for an argument-worthy premise, based on human curator judgment, or machine-learning algorithms about what that level of performance is. Thus, the application can find hitting streaks and consider whether the streak will continue. Or, the system may find that a specific team has a high rate of stolen third bases against left-handed pitchers, and query whether a player on the team will steal third base in the next scheduled game.

In other aspects, the system also makes it easy to socialize with friends via chat, such as by providing easy access to a social media chat function. The application also allows a user to transmit selected postings to another user directly through an integrated in-application chat/Direct Messaging channel. The posting is formatted for chat exchange to allow the receiving user to react to the posting with the same simple swipe gesture used in the primary posting channel (the news feed). The system may also allow a user to have more fun with the sports the user follows, and together with friends and fellow fans that share the user's interests.

In other examples, the systems allow the user to choose to follow users that are friends and family or otherwise socially known to that user. In other examples, a professional league, team or sports pundit, can use the system to connect with fans. In other examples, the system allows a brand-oriented company to sell to sports fans or to promote a user's business.

In other examples, the system may be a social media application for sports fans that is not just convenient, but also engaging and interactive. It may further allow users to stay connected with a user's sports, friends, and family, and discover other fans. Further, in some examples the user can follow other users to see their Takes on that user's commentary and others can follow that user as well. The system may automatically create personal stories in each user's social media profile by, for example, analyzing the reactions of each user looking for patterns, and creating highlights. These highlights and stories constitute one of the highest forms of personal social media content, and they are of a quality that would be practically impossible for most users to achieve. Each day, users can react to dozens of stories published in the application, encouraged by the premised format of the post and by the simplicity of the swipe action to take a side. The system transforms these user reactions into highly personal and meaningful stories about themselves, their friend, and their heroes, and makes them available in a format they can share in social media.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

Other objects of the systems and methods described herein will, in part, be obvious, and, in part, be shown from the following description of the systems and methods shown herein.

### BRIEF DESCRIPTION OF THE DRAWINGS

The foregoing and other objects and advantages of the systems and methods described herein will be appreciated more fully from the following further description thereof, with reference to the accompanying drawings wherein;

FIG. 1 is a functional block diagram of one system of the type described herein;

FIG. 2 is a pictorial representation of the content creation achieved by the system depicted in FIG. 1;

FIG. 3 depicts one process for aiding a user in generating content;

FIG. 4 is an example of a process to identify a pattern for a Storyline;

FIG. 5 is a more detailed illustration of a publisher processor;

FIG. 6 is an example of the mechanism for quick user reactions that record the user's Take on a post;

FIG. 7 is an example of a sided post displaying Takes by multiple users;

FIG. 8 is an example of a user reaction to a posting transmitted via an integrated in-application chat channel;

FIG. 9 is an example of a personalized story tracker; and

FIGS. 10 and 11 are examples of a personal story generated by the application based on user reactions;

### DESCRIPTION OF THE ILLUSTRATED EMBODIMENTS

To provide an overall understanding of the systems and methods described herein, certain illustrative embodiments will now be described. However, it will be understood by one of ordinary skill in the art that the systems and methods described herein can be adapted and modified for other suitable applications and that such other additions and modifications will not depart from the scope hereof.

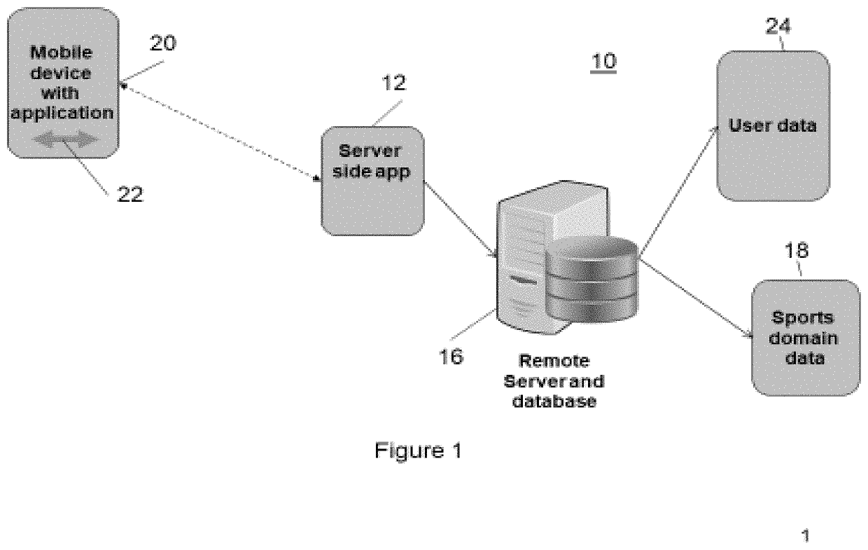

FIG. 1 shows as a functional block diagram one example system 10. In particular, system 10 includes a server-side application 12 that connects bi-directionally, to an application 20 operating on a mobile device. System 10 also includes a remote server and database 16, a dataset 18 of sports domain data and a dataset 24 of user data.

The server-side application 12 operates on the remote server and database 16 and the datasets 18 and 24 are stored in the database of the remote server and database 16. Thus, the system 10 is a client-server application that runs between a remote server and a client device, which will typically be a mobile phone. The system 10, in this example, can run a social media application, the point of which, like almost all social media applications, is to provide the user with social interaction. The depicted system 10, and other systems and methods of the invention, will allow the user to have a better social media experience as it provides a tool that the user can use to readily create content that expresses the user's view on an issue and will publish that content to the user's data feed. Moreover, the system 10 will develop a relationship network for that post of the user, and search through connections in that relationship network to identify activities occurring in that relationship network that are related to that post of the user, and will modify that post to reflect those activities and present them as feedback provided by other users of the system 10.

In this embodiment, the publisher processor 210 processes a data set to identify patterns within the data set that are associated with a list of predetermined themes having one of two possible outcomes and for generating a headline signal that is representative of a machine displayable string of text and being associated with an identified pattern. The identified patterns are the basis for the published Storylines 212A-212C. Each published Storyline 212A-212C may have facts, images and other data and content that are relevant to the identified pattern. For example, in a case where a “Great Match-Up” pattern is identified by the machine learning process, the Storyline 212A may include the data underlying the pattern, such as the points-per-game (PPG) for each of two players matched against each other. For example, if the machine learning process identifies for an upcoming game that Mr. Andre Iguodala of the Miami Heat performs well above his historical average of PPG when playing against Mr. Markieff Morris of the LA Lakers, who also performs well above his historical average of PPG for this match-up, the Storyline 212A can include all this data as well as images of the players and a countdown until tip-off, as shown by the story 214 depicted within the Storyline 212A.

In one example, each published Storyline 212A-212C presents a point of view developed by a machine learning process review of sports data related to an upcoming event, such as an NBA basketball game scheduled for 7:10 pm the following day. The published Storyline 212A presents the point of view by presenting a headline 220. The headline 220 can be a string of text generated by the publisher processor 210. The string of text headline 220 poses a question to the population of users, about the story 214 associated with the headline 220. A user-selectable switch mechanism 218 is incorporated into the published Storyline 212A, typically by use of template code, by the publisher process 210 and presented to the user so that the user can select between two answers offered by the published Storyline 212A.

The server-side application 12 includes the publisher process 210 that generates and publishes the Storylines 212A-212C, in this example embodiment, is a sport-oriented media application. The server-side application 12, in one embodiment, operates as a sports news publisher. To this end, the server-side application 12 performs the tasks typically undertaken by a sports media publication. These tasks will include tasks often undertaken by sports reporters who pour through volumes of sports statistics to identity patterns that suggest a noteworthy performance or event taking place. Such noteworthy performances or events may include highlight performances where the points scored in a game by a particular player may be a career high. In another example, the noteworthy performance may be that a player is a hot streak and scoring far above their statistical norm for points per game. Sometimes, both patterns will occur, such as a player hits a career high as part of a hot streak. In any case, the patterns found are processed by the server-side application 12 using machine learning processes that can editorialize the identified facts. The server-side application 12 editorializing logic identifies which questions best fit the fact pattern for each Storyline 212A-212C, such as “Will the hot streak continue tonight?” or “Is there another career high on-tap for tonight?”, and selects one of the questions based on various criteria. In the systems and methods described herein the published Storyline 212A poses a question derived from the identified data pattern and having two possible answers—typically “yes” and “no”. Thus, in this example, the publisher process 210 of server-side application 12 is processing the domain data 18 to identify patterns of facts that relate to events of interest to sports fans. The server-side application 12 matches the identified pattern found in the domain data 18 to a sports theme, such as a “hot streak” and generates a published Storyline 212A, such as “will Rondo stay hot through the playoffs?” that poses a question that can be understood by a user as having two possible answers. The Storyline 212A can present a meaningful question that fits the headline 220 and additional story facts 214.

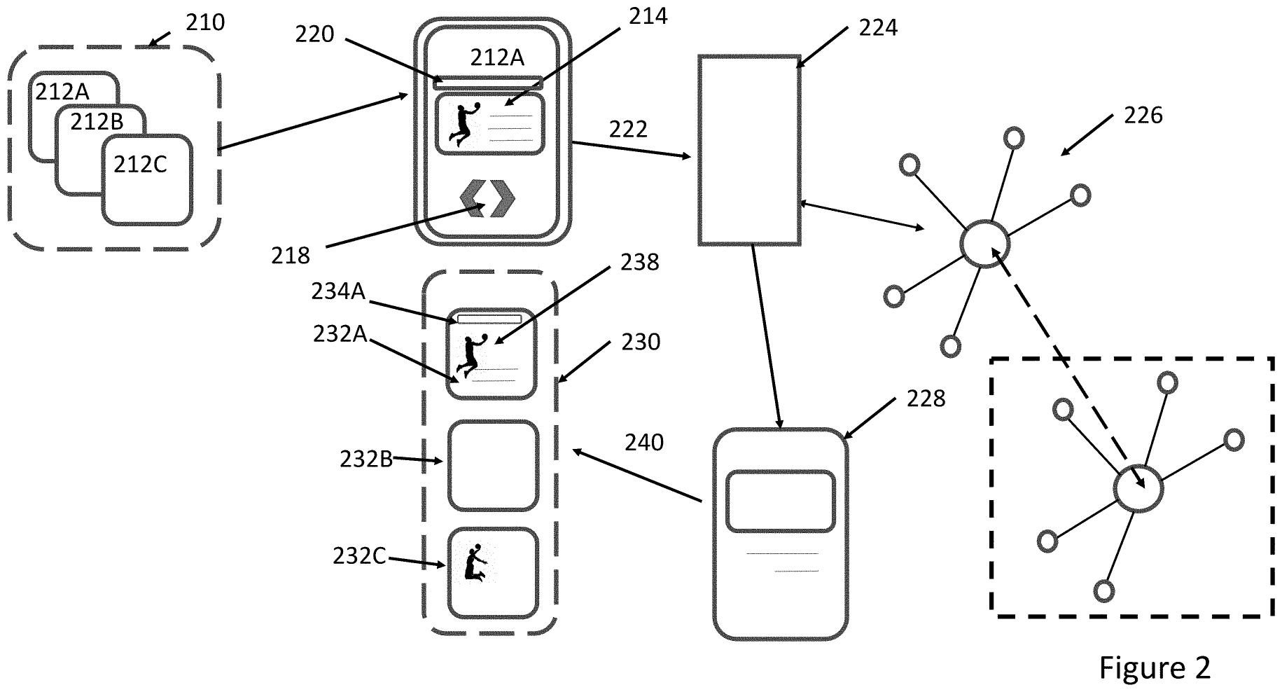

The Storyline 212A is content that the server-side application 12 can publish on to a client application, typically run on a phone. FIG. 2 illustrates that the server-side application 12 in this embodiment publishes content to the client application and that the user can access user selectable switch 218 offered by the user interface of the client application. In one example, the user-selectable switch is a “thumb-swipe” user-interface control that allows the user to use a thumb-swipe to select one of the two possible answers. For example, the user can swipe right to select “Yes, Rondo will stay hot through the playoffs”. This input from the user causes the client application to generate an input signal 222 that the client application sends to a monitoring process 224 of the sever-side application 12.

The monitoring process 224 detects the user input signal 222, determines that the user has claimed Storyline 212A by giving their point of view as to the question posed, and creates a new derivative Storyline for the user. Then server-side application 12 will process the user input signal 222 to generate machine displayable content representing the user's point of view. In this example, the server-side application 12 selects a template 228 that includes a framework of the computer code capable of creating displayable media content. The server-side application 12 can apply the template 228 to generate code that can be published to, in this example, the sports-domain app, or Internet, or other content platform. The content generated by the user through this tool can be published to a data feed 230 associated with an account held by the user of the sports-domain app. A large and diverse volume of published Storylines increases the likelihood that each user in a small circle of friends will be react to a posting that the others in that circle have not seen. This novelty aspect makes it more likely for the other users to perceive the posting as original, authentic, and personal. In this example, the server-side application 12 will apply the template 228 to create content 232A that expresses the user's view point and does so in a way that employs the media capabilities of a computer mark-up language, such as HTML. To this end, the server-side application 12 will create a new headline 234A for the post 232A such as “Mike says “Playoff Rondo” is here for the whole series!”.

This new headline changes the perspective of the story from a discussion about Rondo's performance, to one about Mike, the user, and Mike's belief in Rondo's ability during the NBA playoffs. This new content is a cloned version of the original Storyline 212A that is now amended to change the headline to publish content of the user's input signal 222, and present it as a viewpoint on the Storyline 212A claimed by that user.

FIG. 2 illustrates that the user can choose to claim all the Storylines 212A-212C generated and published by the system 10 and the system 10 will support the user in creating, using template code 228, a series of derivative content posts 232A-232C that are published within the user data feed 230. The data feed 230 depicted in FIG. 2 includes a series of content posts, sometimes called “claimed takes”, each having the user's perspective presented in a headline 234. The depicted data feed 230 is a published set of user “takes” each of which is tied to an upcoming event, typically a game that is scheduled to play in the next day or two, each of which “take” publishes the user's perspective on a story associated with that game, and each of which, as will be explained below, may be continuously updated by the monitoring process 224 to present replies to the user's take, for example, whether other users of the app have taken an opposing position or similar position to the position taken by this user, as well as machine generated replies about the sport game play each quarter and whether the game play suggests whether the take by the user will be correct or incorrect.

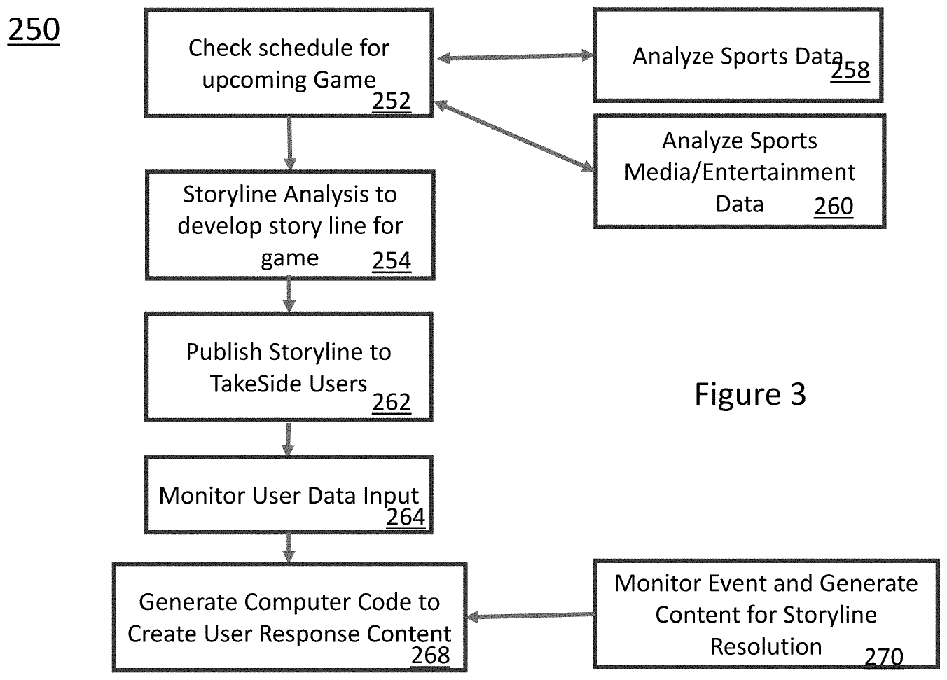

To this end, the server-side application 12 includes machine learning processes that process the sports domain data 18 to identify patterns in the data and to generate Storylines from these patterns. Sports domain data has a format that is known and common statistics, such as points-per-game, game lineup, field goal percentage and others such statistics are recorded during each game and stored as part of the sports domain data 18. In some embodiments, the sports domain data 18 is purchased from a third-party supplier, and many of the commercially available suppliers of such data provide sports domain data suitable for use with the systems and methods described herein. One example method is depicted in FIG. 3 which illustrates a process 250 for processing data into Storylines, publishing the Storylines to the users and allowing the users to claim a Storyline by entering user input that the process 250 then publishes by cloning the Storyline, using a template to integrate the user input with content from the cloned Storyline, supplementing the clone with code that may add additional media and content and publishing the supplemented media message as user generated data within the user data feed. As further depicted, the process 250, in this embodiment, monitors for the user activities and events that are relevant to the content posted by the user and may update the content as a function of the activities and events.

Turning to FIG. 3, the process 250 begins at step 252 where the process 250 checks for an upcoming game. To this end, the process 250 enacts step 258 and checks a database of sports data that includes the schedule of games, and step 252 may compare that schedule against an internal calendar that indicates present data and time. This comparison can identify games scheduled to occur within a time window selected by the process 250, such as within two days of the current time.

In one example, the step 258 conducts an extensive search. For example, in some embodiments the database of sports domain data includes schedules for multiple sports, multiple leagues for all teams in those leagues. Thus, it may contain all schedules for the NFL, NBA, NCAA, Premier Soccer, Six Nations Rugby, High School Leagues, and more.

Additionally, the sports domain database 18 can include extensive sports data about all the teams and players in these different leagues and sports, such as the line-up of players set to play in upcoming games and historical performances of the players and teams. Thus, in step 252 the process 250 may identify dozens of games scheduled to be played during the time window, involving hundreds of players with an enormous number of team and player matchups and combinations. The process 250 can employ machine learning processes to analyze this extensive range of sports data and to identify patterns that are associated by the process 250 as relevant to a sports story. The combinatorial complexity in certain domains such as sports support large volumes of diverse patterns. Tens of leagues, dozens of games, hundreds of teams, thousands of players, and scores of statistical performance metrics can be combined to create millions of potentially interesting patterns every game day.

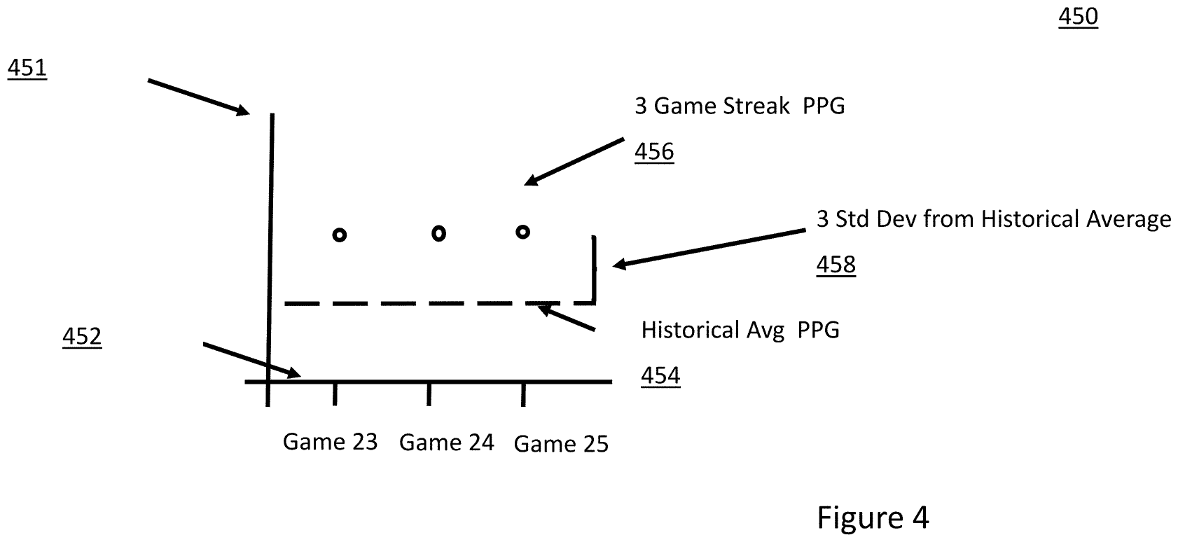

To this end, the process 250 may proceed to step 254 and analyze the patterns identified to develop Storylines. In one embodiment, the process 250 applies a series of rules that apply testable characterizations of a Storyline. For example, in step 254 the identified patterns can be checked for whether they include a “Hot Streak?” storyline, wherein such a pattern shows that a protagonist, typically a player, but it can be a coach or other party, has outperformed their statistical average for three games in a row. Such a pattern can be identified using a process such as that depicted in FIG. 4. FIG. 4 depicts pictorially a pattern recognition and learning process 450 for identifying a scoring hot streak. FIG. 4 shows a y-axis 451 for points scored, an x-axis for game event and three games, 23, 24 and 25. In the process depicted the learning process has learned from monitoring user activity and sports media activity, that scoring streaks over three games during which each game has scoring that is three or more standard deviations 458 from the historical average 454 for the player, excites interest from the users of the app. Techniques for determining this “hot streak” rule using machine learning are known in the art and may include Generate and Test paradigms that employ historical data to identify the rule. Such techniques are known to those of skill in the art, including the techniques discussed in Artificial Intelligence, Patrick Henry Winston, Addison-Wesley Publishing Company (1984), the contents of which are incorporated by reference.

Another example, may be whether the data includes a pattern for a “Breakout Rookie?” Storyline. Such a pattern may be identified by having process 250 in step 254 analyze the sports data to find whether a player in their rookie season is having a superior points per game average performance as compared to other rookies that season and as compared to historical averages for rookie performances. The pattern identification process may set thresholds for each of these comparisons. For example, the process 250 in step 254 may set a comparison that identifies a rookie scoring more than two standard deviations above the PPG average of other rookies over comparable playing time windows, for example twenty quarters of playing time. The process 250 in step 254 may set, for any rookie identified in this first comparison, a second comparison that compares these identified rookies to historical performances of other rookies and sets a one standard deviation threshold for that comparison. A provocative Storyline can be developed from such comparisons, such as “Will rookie Ja Morant continue to outperform Michael Jordan's rookie year tonight against the Pelicans?”. Again, machine learning may be employed in step 254 to set thresholds for the point differential needed by a “rookie” to gain attention of the users of the app. In one embodiment, the machine learning process applied in step 254 may measure a “media attention” factor that shows the number of mentions for that rookie in sports entertainment media 260 to cross a certain threshold indicating interest by users. The machine learning process may also use information from a user profile to adjust such thresholds. Thus, if a user has expressed an interest in a certain rookie or a team having a number of rookies, the threshold needed for such preferred rookies to be deemed a “breakout” rookie for a Storyline may be reduced.

In some cases, a pattern may fit one or more stories, such as Breakout Rookie and Hot Streak. Additionally, the process 250 may identify, for the many games within the set time window, a series of candidate Storylines, for different ones of the respective games. In this case, the process in step 254 can prioritize one Storyline over the other, and select the highest priority for publication. Prioritization can be made using any suitable method, and in one particular embodiment, Storylines that have reliable statistical support, such as “Hot Streak?”, are prioritized over Stories that have more complex and nuanced, and therefore less clearly correct, propositions, such as “Breakout Rookie”. Additionally, Storylines for games related to sports and leagues identified in a user profile as of interest to a user of the app may be prioritized for publication. In one embodiment, the Storyline machine learning process 252 tracks and analyzes the frequency with which each pattern appears, to determine which patterns are more or less frequent than others. The Storyline machine learning process 252 provides a higher priority to less frequent patterns (rare patterns). The Storyline machine learning process 252 may also track and analyze the frequency with which users react to certain patterns and give priority to the more popular patterns (storylines that users swipe on the most).

Prioritization may be based on still other factors. In one embodiment, the process 250 can assess popularity of the protagonists in a pattern that is a candidate Storyline, and popularity may be used to prioritize identified patterns. The process in step 260 may check sports media/entertainment data, and can check information that represents popularity or interest in certain relevant topics to the detected patterns. For example, the process in step 260 can check the sports media/entertainment data to analyze headlines and count the number of mentions of league, players or teams that were made in sports entertainment media, such as on the NBA sports blog, and assess issues of current popularity and interest in certain players, teams, leagues and matchups. The system can weigh the patterns based, in part, on whether the protagonists in the detected pattern (players and teams for example) are seen as popular. This would likely move patterns involving playoff games ahead of patterns found for games still in the regular season. This data can be used in step 252 to rank patterns found in the sports data, and in one example will be used to rank patterns that are associated with popular teams, matchups or players higher than other sports data. Additionally, in embodiments where the user enters profile data, or where the system 10 monitors user activity and builds a profile of interests for that user, that profile may be used to identify players, teams, and matchup that may be of inters to one or more users and provide a hither rank to patterns associated with those players and teams. Based on this detection and prioritization of patterns, Storyline machine learning process 252 can select a Storyline for the content post. In any case it is expected that the process in step 254 will often generate far more patterns that are candidates for Storylines than the process 250 will publish to the users in step 262 and prioritization will, in part, support reduction of the number of candidates for Storylines.

In preferred embodiments, the “question” posed in the Storyline is meant to be “argument worthy” since this means that regardless of which answer the user picks, the Storyline will be more likely to cause other users to challenge the answer picked. Meaningful social connections require an exchange of content, so it is critical that the content generated and shared have the potential to generate a response. In one embodiment, a Storyline is made argument worthy by determining a Storyline that has two outcomes, each outcome having an equal chance of occurring. Thus, returning to the example of FIG. 4, the machine learning process may select certain parameters, such as the use of three standards of deviation and a sequence of three games as regression analysis showed that the likelihood of a streak at this level continuing for a fourth game is close to 50 percent. Therefore, a user is provided with two credible choices, yes or no, both having merit and both allowing the user to select a credible option to post as their personal content on their data feed 230. It is a realization of the systems and methods described herein that this feature improves the likelihood of users “swiping” to generate content. In part this feature mitigates the prospect that a user will share their personal content and this sharing will not lead to the meaningful exchange they seek, and that they will get no response in return to making a post about their opinion. The prospect of receiving no feedback to their personal content can be a daunting prospect for a user, and deters users from creating content. An element of the systems and methods described herein is helping users create content that will automatically generate a response in return. Users want to engage in a meaningful exchange, which relies upon two-way communication. Notably, the systems and methods described herein operate to generate a response for the user even when other users do not react. Specifically, the systems and methods described herein will send updates to the user as the story unfolds through resolution. Since the source of these updates are real-world actions by people that the user cares about, such as his favorite players, these exchanges are perceived as meaningful interactions by the user.

In certain embodiments, User Profiles are used as the process 250 looks to make additional “meaningful” connections after the initial swipe. The process 250 initiates communication with the user through its posting of Storylines, a process that can be called a News Feed. Each content post “Take” is designed to provoke a reaction (a swipe) from the user and the user entering an answer to the Storyline. The process 250 implements an expansive interpretation of the user-swipe by not only responding to it, but also creating a micro-graph for that Take. The Take micro-graph establishes a “live and dynamic” connection between the user and a constellation of protagonists that are connected to that Take (a league, one or two teams, one or two players, a statistic, a headline, two communities on each side, users followed, and friends that follow the user back), and that, from a social media perspective, carry kinetic or relationship energy potential that the process 250 can employ to generate follow-on responses. The process 250 creates meaningful responses that are designed to facilitate one or more social engagements for the user (and whenever possible to provoke a fresh user reaction). The process 250 may mine each recent Take micro-graph looking for follow-on (delayed) responses that the user is likely to find valuable and enjoy consuming, and that could be used by the process 250 to provoke a new user reaction such as a swipe, a message, or a comment, and which potentially causes a new relationship 226 graph to be created or to expand the existing one. As the process 250 mines each relationship graph 226, it evaluates changes in state at each node such as a player scoring or the game reaching half-time scores, and then publishes the changes that have the highest potential to trigger a new response from the user. The process will give priority to updates from real users over those from para-social relationships. The process also keeps track of the type of updates it has delivered to minimize repetition, facilitate a “variable surprise” effect, and make it easier for the user to perceive the updates from para-social relationships as personally meaningful and authentic. Although the process gives priority to updates related to recent user actions, some responses generated may be linked to user reactions that are several days old. If the process 250 cannot find any meaningful updates available in recent relationship graphs 226, then it will mine older relationship graphs. Although it prioritizes significant domain related insights (responses) from more recent and more direct connections, the process facilitates domain related social interactions with the user, and will consider data as far back as it takes until it finds at least one meaningful response. An aspect of the systems and methods described herein is that a user can count on the process 250 to reliably act as be a responsive and interactive counterparty even during periods when real people in the user's social network are inactive.

After the Storyline is developed and selected, the process in step 262 publishes the Storylines to the users. As discussed above with reference to FIG. 2, a Storyline can be published as a content post 212 that includes a headline 220 and a story, typically just consisting of data relevant to the Storyline, such as the average points per game for a player and their current three game points per game streak. The content post 212 of FIG. 2 also includes a user selectable switch 218. In the preferred embodiment the Storyline is posed as a question and the user selectable switch allows the user to select between the two answers that can be entered for the question posed.

The process in step 264 monitors whether a user chooses to act on a Storyline and enter that user's input on that Storyline, giving that user's view on the premise set out in the Storyline. For example, a user can swipe right to indicate they believe a “Hot Streak?” will continue or swipe left and indicate that think the “Hot Streak” is coming to an end.

Once a user input is detected, the process 250 in step 268 will take the user input and build out the computer code for expressing that user's view in a format that is capable of publication in a computer application. To this end, the process in step 268 can access a template of computer code and use that template to format the user's input. That generated code can be published by the process 250 to the user data feed and shared in the News Feeds of other users that follow the user.

As further shown in FIG. 3, the process 250 in step 270 may include a process that monitors information relevant to the content post, that is the users “Take”, such as the game action, new user reactions, and results. In step 270 the process 250 may performed in real-time and upon discrete events such end of quarter or start of calendar day. The process 250 in step 270 may alter the content post in a manner that is relevant to the user, such as “I have called it right so far!”, if the streak at half-time is holding up, or “My man needs more floor time!”, if the streak is in peril.

Turning now to one further particular example of how the process 250 can identify a Storyline, the following begins with the sports domain data 18 which typically will include relevant historical data of NBA performances. To this end, the sports domain data 18 may be a compilation of data provided by the NBA, typically as part of a subscription service, that includes relevant data for each player during each game. In one example, the sports domain data 18 may include data such as the data in Table 1 below.

| Team | Opponent | Score | Date |
|---|---|---|---|
| Lakers | Celtics | 100-108 | Nov. 10, 2018 |
| | Nuggets | 120-108 | Nov. 12, 2018 |
| | Golden State | 95-68 | Nov. 15, 2018 |

And another set of tables for the players that competed during these games; such as shown in Table 2 below.

| Player | Points | Rebounds | Assists | Opponent | Date |
|---|---|---|---|---|---|
| Chris Paul | 20 | 3 | 3 | Celtics | Nov. 10, 2018 |
| Steph Curry | 25 | 4 | 2 | Lakers | Nov. 10, 2018 |
| Jaylen Brown | 10 | 0 | 1 | Pistons | Nov. 10, 2018 |
| James Harden | 18 | 2 | 1 | Raptors | Nov. 10, 2018 |

The server-side application 12 can apply machine learning processes that analyze the data in these tables to find notable patterns of the type that provoke a question or opinion from the traditional NBA fan. For example, the machine learning processes may look for scoring streaks, or whether any player had a “triple double” streak started, which means ten or more points, rebounds and assists. Further, the machine learning processes may apply statistical review to find trends that are other-than-normal, and perhaps even extraordinary, such as James Harden almost always outscores the combined score of the two best players on the Pelicans when Mr. Harden's team plays the Pelicans. If Mr. Harden will face the Pelicans tonight, the server-side application 12 may identify this upcoming game as a newsworthy event and can use this identified Storyline pattern, and combine that Storyline with the newsworthy event of the upcoming game tonight, to formulate a headline that poses a question to post about the likelihood that Mr. Harden maintains his streak. In one other example, the server-side application 12 may run a machine learning process that looks for streaks that are at risk in tonight's game and are unusual as measured by the streak's deviation from a relevant statistical mean. For example, the machine learning processes may search for streaks that are at risk tonight and that are two standards of deviation away from the average performance for a particular player's position. This information can be packaged with a provocative headline posed as a question with two possible answers (“yes” and “no”), such as “Is James Harden the most dominant point guard that the Pelicans face?” Alternatively, the machine learning processes can find trends that are well within expected performance of a player and can package that statistically normal performance with a “teaser” type message likely to provoke a reply from a user. One example of a teaser may be if Mr. Harden's recent performance does not exhibit noteworthy patterns, the system and methods described herein may adjust the question to tease the user with an unlikely proposition about the outcome so as to provoke a reaction.

The server-side application 12 can also include machine learning processes that analyze the dataset 24 of user data to find notable patterns in the user's reactions to published Storylines 212A-212C. For example, user reactions may reveal particular concentrations of interest in certain games, players, or teams, as well as interesting biases for or against certain games, players, teams, or users. For example, the machine learning processes may highlight for the user a high level of interest in Mr. Harden or the Pelicans, as well as expose a current tendency to root for the Pelicans or challenging the Takes of a particular other user.

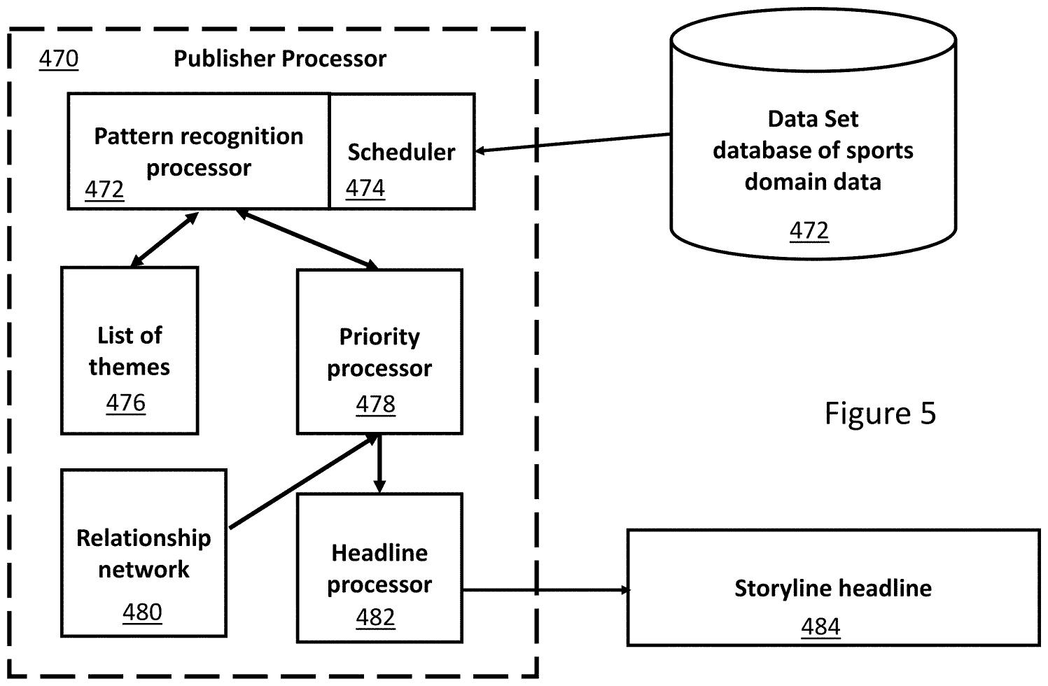

FIG. 5 depicts on example of a publisher processor 470 capable of carrying out the method described above to generate Storylines to aid a user with creating machine displayable content for a data feed published to an account associated with the user. The publisher processor 470 will generate Storylines with a user-interface for presenting a question and two choices as user-selectable answers for the respective question, and for presenting a user-selectable switch for selecting one of the two choices. The question refers to a future outcome that cannot be known at the time, but that will unfold over a relatively short period of time, and will be resolved with clarity in the near future such that the correct answer will be known and can be verified unambiguously. The publisher processor 470 processes data from the sports data set 472 to identify patterns within the data set that are associated with a list of predetermined themes 476 having one of two possible outcomes and for generating a headline signal 484 representative of a machine displayable string of text and being associated with an identified pattern. The predetermined list of themes may be as described above “Hot Streak”, “Breakout Rookie”, “Highlight Performance”, “Big Performance”, “Trending Up/Down”; “Repeat”, “Bounce Back”, “Back to Reality” or any other suitable theme for the sports domain and capable of being associated with a pattern that can be statistically identified from the data set 472. The publishing processor 470 may further include a scheduler process 474 for determining a schedule, or any time sequence, of games in the data set 472 that occur within a time window set by the publishing processor as relevant for the pattern detection process. The publishing processor 470 as discussed above has a pattern recognition process 472 that will analyze data relevant to those games in the time window and generate, using the list of themes, 476, a series of patterns that are candidates for storylines. The publishing processor 470 may further include a prioritization processor 478 for ranking the candidates identified by the storyline processor 472 into a ranked list of themes. The priority processor 478 may connect to the relationship network processor 478 that will identify relationships associated with the different candidates and the priority processor 478 can also use those identified relationships to set priority for the candidates for storylines. The priority processor 478 can send to the editorial headline processor 482 the candidates to be made into Storylines. The editorial headline processor 482 can process the candidate strings, which are typically a string of text, such as “Hot Streak”, associated with the identified pattern. The headline processor 482 can alter sections of the string to include a string of event data associated with upcoming event and the patterns, such as by altering the string to “Is Harden on a Hot Streak?” or “Will Harden's Hot Streak End Wednesday night?”. The editorial headline processor 482 can use the relevant data associated with the game to create strings for altering the headline, including a player name, game, and team name or other fact associated with the identified pattern. In one embodiment, the headline processor 482 stores a series of template strings for each theme, such as the theme “Hot Streak”. The template string can include in one example, a string for the theme, such as the text string “Will [player X]'s hot streak end [event time]”. The template string can include a formulation of the theme, such as Will X's hot streak end?, as well as replaceable string variables, such as [player X], and [event time]. The headline processor 482 can use a string replacement process to replace the replaceable string variables with text strings that present in a displayable form data associated with the Storyline, such as the player's name, in this example Mr. Harden, the event time, in this example Wednesday night, or in other examples, it could be tonight at 7 pm?”. In one embodiment, the systems and methods described herein use a headline processor 482 that is a python process that uses the string processing functions of python including substitute and concatenate. Other string replacement processes are known in the art including those set out in U.S. Pat. No. 9,542,928.

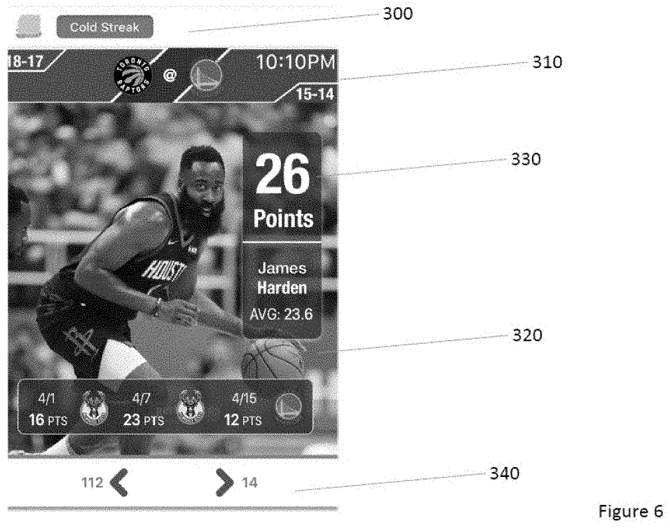

An example of a Storyline is set out in FIG. 6 which depicts a Storyline post that would be generated by the server-side application 12 after detecting a pattern of below average performances by Mr. Harden. FIG. 6 shows the Storyline headline “Cold Streak” 300, a game banner 310 with the details of the proximal event (teams, team records, and game time), details about the protagonist 320 to help frame the storyline (name, recent record, and season average), a success threshold 330 that is calculated based on the protagonist record and upcoming match up (the machine learning processes proposed 26 points or above as a successful performance for Mr. Harden given his recent record, long-term point averages, and the record of the Golden Gate Warriors). This Storyline asks the user to back or challenge the proposition that Mr. Harden will succeed at scoring 26 points or above in the 10:10 PM game against the Warriors. The post displays the then current number of users 340 that are siding with or challenging Mr. Harden's scoring performance against the system proposed success threshold.

In one embodiment, the server-side application 12 facilitates the creation of content by providing a template. FIG. 6 illustrates an example of media produces with such a template. The template may be an HTML or other protocol compliant template that collects data relevant to the issue or take identified by the server-side application 12. The server-side application 12 formats the post into a template. The template, in the FIG. 6 includes a picture of Mr. Harden, a proposal that he may or may not get “26 Points” for the game depicted graphically as the 10:10 pm game between the Raptors and the Golden State Warriors. The graphics, the depiction of the proposal about 26 points, all may be pre-formulated as a template that the server-side application 12 generates. User reactions to the premise are recorded by the application and integrated into the post because it extends the Storyline, and users find themselves to be newsworthy, and perceive it as personal content. Users known to each other personally and connected by a social/relationship graph maintained on the server-side application 12, will often regard each other's opinions and feelings about Mr. Harden's performance as newsworthy as Mr. Harden's performance, sometimes even more newsworthy. Similarly, popular topics can attract large communities of followers who regard global opinion and sentiment about events and protagonists as newsworthy as the events and protagonist performances.

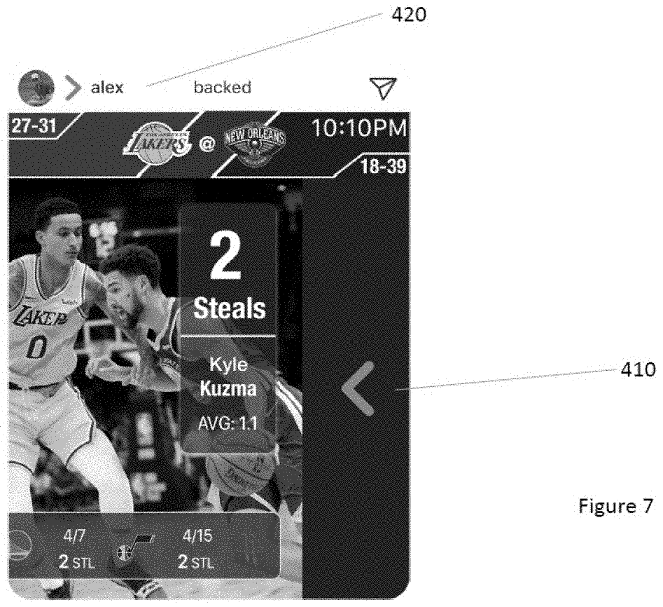

FIG. 7 depicts the quick reaction mechanism provided to users. Each post template includes a simple user interface 410 that makes it easy and clear which side the user is taking regarding the upcoming performance of the storyline protagonist. That user interface 410 allows use users to swipe left for “no” and right for “yes” to challenge or side with the protagonist (respectively). In this example, the post also displays data collected from other users of the application that have reacted to the same Storyline. In this case user Alex “swiped right” to indicate “yes” (420) to indicate that Alex believes or roots for Mr. Kuzma to earn 2 or more steals in the 10:10 pm game that night. In this example, the user is swiping left to indicate that he is challenging both Mr. Kuma's performance and Alex's take on Mr. Kuma's performance. Notably, when user Alex discovered the Storyline in his News Feed, the headline that caught his attention was the “Hot Streak” that Mr. Kuzma was experiencing on Steals. However, when other users that follow user Alex later discover the Storyline in their News Feed, the headline that catches their attention is that user Alex is backing Mr. Kuzma to extend his “Hot Streak” with another performance of 2 or more Steals in the 10:10 PM game. All this user input can be done using the mobile device with application 20 depicted in FIG. 1. That mobile device 20 is shown as having a simple user interface 22 that allows for thumb swipes right or left to enter the user's input. The application on mobile device 20 can send information back to the server application 12. The server application 12 can generate new versions of the post that reflect the new challenge to Mr. Kuma's performance and Alex's personal take on Mr. Kuma's performance.

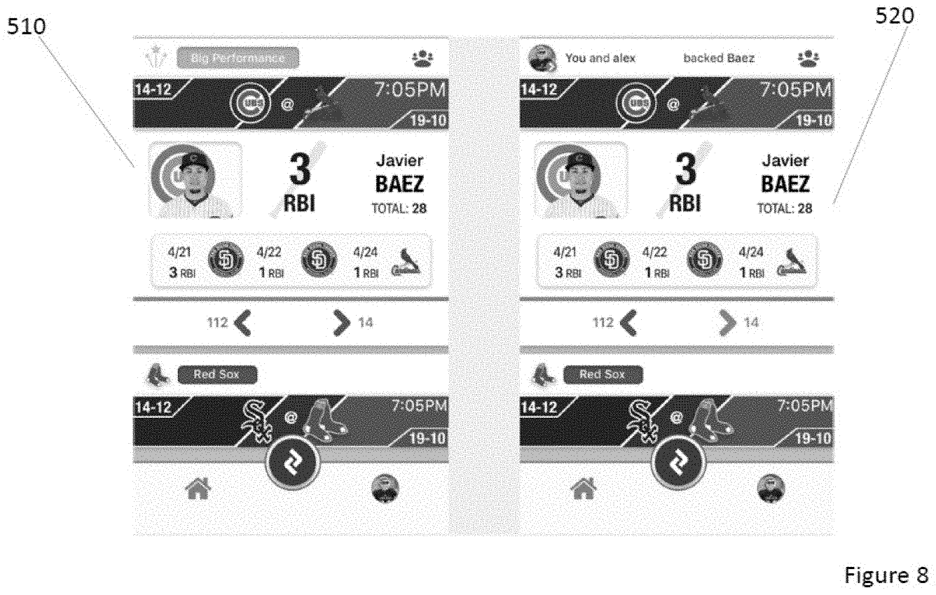

The application on mobile device 20 can send information back to the server application 12. The server application 12 generates posts and routes them to the appropriate user devices 20, for example, doing so, depending on each user's relationship graph. Posts 510 and 520 on FIG. 8 are for the same Storyline. They both report on Mr. Baez recent RBI performance and upcoming coming schedule game (7:05 pm that night). Critically, for users that are not connected to other users that have sided on this storyline, the headline on post 510 highlights the Mr. Baez “Big Performance” in his last game. However, for user Berto, the headline on post 520 highlights Berta's and Alex reaction to the story about Mr. Baez's recent and upcoming performance. For users, connected to users Berto and Alex through the relationship graph maintained by server application 12, Berta's and Alex's opinions and feelings about Mr. Baez's recent and upcoming performance are newsworthy. For each user, the application on mobile device 20 will prioritize posts that publish reactions from other users with whom he or she is connected. The result is that with every reaction from connected users, each post becomes increasingly personalized, and every user is readily transformed into a prolific content generator. Notably, for other users that follow users Alex and Berto, when they discover the Mr. Baez RBI Storyline, the headline that catches their attention is that user Alex and Berto are backing Mr. Baez to have another strong RBI performance. These other users will perceive the Storyline as personally meaningful content from people they know.

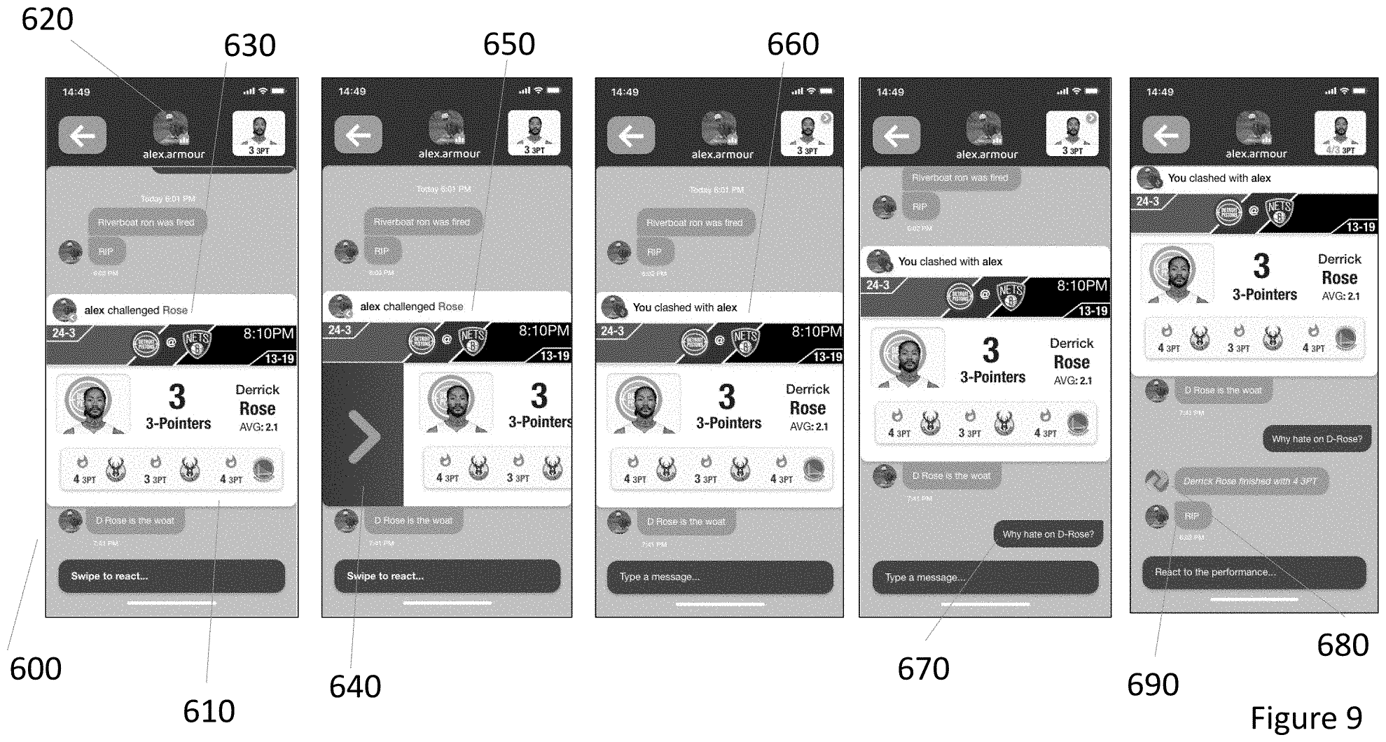

In one embodiment, the server-side application 12 facilitates the creation of personalized content by allowing one user to transmit individual Storylines to another user directly through an integrated in-application chat/Direct Messaging channel 600. FIG. 9 illustrates this mechanism. The application also allows one user to transmit individual Storylines to another user directly through an integrated in-application chat/Direct Messaging channel. Importantly, the transmitted Storyline 610 is formatted to allow the receiving user to react with the same simple swipe gesture used in the News Feed. In this example, user Alex 620 has shared his Take on a story about Mr. Rose's performance with another user. Alex challenged 630 the premise that Mr. Rose will have 3 or more 3-Pointers in the 8:10 pm game against the Nets. If the user that received the message from Alex swipes right 640, it means the user backs the premise that Mr. Rose will have 3 or more 3-Pointers in that game, and clash with user Alex's Take on the same premise 650. The user's reaction 660 is now added to the Storyline, and becomes part of the post. Either user can then leverage the media context in this channel for additional follow-on exchanges with little effort. In this case the user adds brief commentary 670 to his swipe reaction (“Why hate on D-Rose?”). Direct Messaging is regarded as a much more personal communication channel than a social media News Feed. Moreover, unlike social media posts shared for News Feed consumption, Direct Messages carry with them an expectation of a response because they are directed to a specific user. Therefore, a Storyline shared with another user via Direct Message will be strongly perceived by the recipient as personally meaningful content, and requiring a response. Critically, the application mines the relationship graph associated with each Take and evaluates changes in state at each node such as a player scoring, and then publishes the changes that have the highest potential to trigger a new response from the user. An aspect of the systems and methods described herein is that a user can count on the application to reliably act as be a responsive and interactive counterparty even during periods when real people in the user's social network are inactive. In this case, the application automatically generates and publishes an update 680 in the Direct Messaging channel shared by these users, which will be perceived by both users as a personally meaningful and authentic communication from a para-social relationship (from Mr. Rose in this example). Moreover, the para-social interaction will often trigger a social interaction 690 between real people that share that para-social connection.

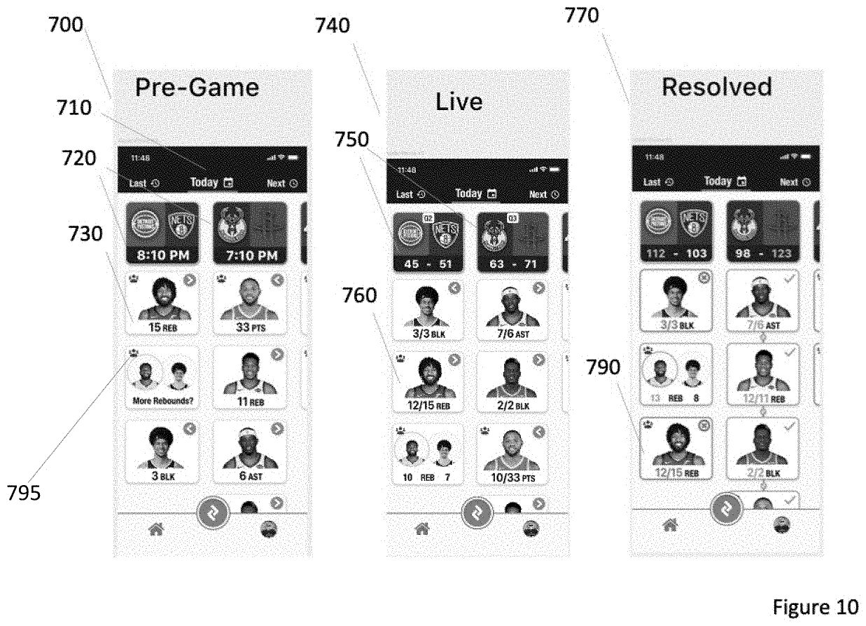

The server-side application 12 can record all the reactions offered by the user and publish that data in a format that allows the user to track a high volume of storylines and Takes using the application on mobile device 20. The application provides each user with a personalized story tracker to help monitor and manage every Storyline and Take by date and by game, so the user can navigate and stay on top of hundreds of active Storylines at the same time and in real-time. Such personalized story tracking system also makes it possible for the user to add follow-up reactions to the Storyline as it evolves based on the performances of the protagonist and the reactions of other users he or she is connected in his or her social graph. The systems and methods described herein significantly improve publishing participation, volume and speed about a topic, as well as increasing ease of content production by each user. It is practically impossible for a user to generate or track such high volumes of content manually. FIG. 10 illustrates one such mechanism that makes this possible in the application.

For example, FIG. 10 shows the state of a user's personalized story tracker over time. Tracker 700 displays Storylines for games scheduled for Today 710 but that have not started. The user has sided in Storylines for the 8:10 pm and 7:10 pm games. In one Storyline 730 the user has sided with the premise that a player will get 15 or more Rebounds. Tracker 740 displays Storylines for the same games 750. The application reports on the current status of the stories. Storyline 760 reports that the player has completed 12 Rebounds so far. Tracker 770 displays the final resolution of the storylines. Storyline tracker 790 reports that the player failed to complete 15 Rebounds so the user backed the wrong side. Importantly, the application makes it easy for users to add follow-up personal reactions to any of the storylines as they evolve. Each Storyline tracker displays an indicator 795 to let a user know if other users that he or she follows have also made the same Take.

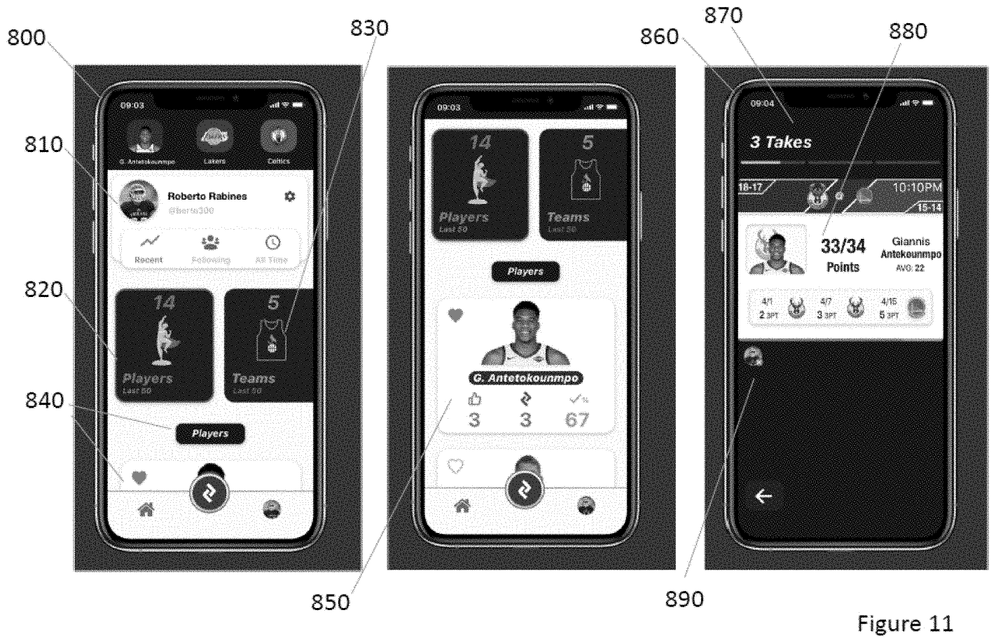

Again, the depicted server-side application 12 in this example, records each user reaction and looks for patterns that can be used to generate and publish personally meaningful content on behalf of the user. The server-side application 12 can also include algorithms that analyze user data to find notable patterns in user reactions to published Storylines. User reactions may reveal particular concentrations of interest in certain games, players, or teams, as well as interesting emerging patterns their relationships with certain games, players, teams, or users. The server application 12 generates new and original personal stories that combined topic events and user data and routes them to the appropriate user devices 20 depending on each user social graph. These personal stories are experienced by these users as authentic content, and with a media quality and volume not possible for most users. FIG. 11 illustrates one such mechanism that makes this possible in the application. For example, FIG. 11 shows the profile page 800 for user Roberto 810. It displays stories about Roberto's recent reactions to Player 820 and Team 830 Storylines. The application reports that user Roberto has recently reacted to Storyline about 14 different players 820 and 5 different teams. The application publishes highlights 840 and 850 that reveal patterns in Roberto's reactions to specific players. Equivalent highlights are available for Teams 830. For example, user Roberto recently reacted to three (3) Storylines about Mr. Antetokounmpo. Tapping on the personal story highlight will cause the application to display the individual Storylines aggregated in the highlight 860. In this example, three (3) Storylines 870 support the notable pattern, and additional details 880 and 890 combine to tell a seamless story about the recent actions by user Roberto and Mr. Antetokounmpo. User Roberto, as well as any user connected to user Roberto through the social graph maintained in the server-side application 12, has access to these personal stories. The result is that for other users connected to user Roberto through a social media following relationship, the initial posts are no longer just news and editorial analysis of Mr. Antetokounmpo's performance, but timely, significant and interesting personal news from and about regular people like Roberto that matter to them as much or more than Mr. Antetokounmpo.

The systems and methods described herein allow a user to easily generate and publish content to a social media application. The systems and methods analyze data to identify a newsworthy topic, formulate that topic into an issue with binary outcomes, allow a user to select the outcome they want using a simple thumb-swipe, and format that user thumb-swipe into content suitable for publishing on the social media application. These systems and methods implement an expansive interpretation of the user swipe by establishing a live and dynamic connection between the user and a constellation of active agents perceived as meaningful through pre-existing social and para-social relationships. These systems and methods use these connections to reliably act as be a responsive and interactive counterparty even during periods when real people in the user's social network are inactive. Such systems and methods make engaging with others through social media easier, and in particular, make it easier to generate personal content that will allow for one user to engage with and make a social connection to another user.

The depicted data processing system of FIG. 1 may be a conventional data processing platform such as an IBM PC-compatible computer running the Windows operating systems, or cloud server running the Linux operating system. The system of FIG. 1 may be configured as a web server or service.

Although FIG. 1 graphically depicts the system 10 as functional block elements, it will be apparent to one of ordinary skill in the art that these elements can be realized as computer programs or portions of computer programs that are capable of running on the depicted server platform 16 and mobile device 20 to configure them into a system as described herein. Thus, the system 10 can be realized, in part, as a software component operating on a data processing system. In that embodiment, the system 10 can be implemented as a C language computer program, or a computer program written in any high-level language including C++, Fortran, Java or BASIC.

The depicted database in sever 16 can be any suitable database system, including the commercially available Microsoft Access database, and can be a local or distributed database system. The design and development of suitable database systems are described in McGovern et al., A Guide to Sybase and SQL Server, Addison-Wesley (1993).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

What is claimed is:

1. A system for aiding a user with creating machine displayable content for a data feed published to an account associated with the user, comprising:
a user-interface for presenting a question and two choices as user-selectable answers for the respective question, and for presenting a user-selectable switch for selecting one of the two choices;
a first processor for monitoring the user-selectable switch to detect a signal representative of a choice selection by the user, and for selecting a template representing a format for media content and generating, in response to the choice selection, computer code for directing the creation of a computer readable media message capable of displaying the choice selection and having the format associated with the template; and
a second processor for interpreting the computer readable media message to publish the media message as machine displayable content appearing as part of the data feed published within the account associated with the user.

2. The structure of claim 1, further comprising
a publisher processor for processing a data set to identify patterns within the data set that are associated with a list of predetermined themes having one of two possible outcomes and for generating a headline signal representative of a machine displayable string of text and being associated with an identified pattern.

3. The system of claim 2, wherein the publisher processor further comprises
a headline string processor for selecting a premise string representative of a string of text associated with an identified pattern and for altering sections of the premise string to include a string of event data associated with at least one of a player, game, and team associated with the identified pattern, and altering the premise string of text to include a string of even data.

4. The system of claim 2, wherein the publisher processor further comprises
a prioritization processor for ranking one or more themes identified by the publisher processor into a ranked list of prioritized themes.

5. The system of claim 2, wherein the publisher processor further comprises
a scheduler for determining a time sequence of events associated with the data set and for identifying patterns being associated with one or more of the events.

6. The system of claim 2, wherein the first processor further includes
a user statement generator for replacing the headline signal with a user statement string representative of a machine displayable string of text setting out the user choice selection.

7. The system of claim 1, wherein the template includes a section for supporting image data within the media message and a section for supporting text representative of the user-selected choice.

8. The system of claim 1, further comprising
a network processor for monitoring the user's activity within the user account and creating a network of relationships, wherein the relationship is representative of an association between the user and a second user of the system and wherein the association is determined based on monitoring the choices selected by the user.

9. The system of claim 8, wherein
the template includes computer code for generating messages to other users of the system within the network of relationships and wherein the messages communicate to the second user the choice selected by the user.

10. The system of claim 8, wherein the network processor further includes
a content processor for processing the network of relationships to identify activities associated with the users in the network of relationships and to generate content as a function of identified activities to add to the media message.

11. The system of claim 8, further including
a response processor for identifying activities of a second user representative of a response by that second user to the message communicating the choice selected by the user, and for generating an update for the media message.

12. The system of claim 1, wherein
the template includes HTML compliant code for instructing an HTML browser to generate the displayable media message.

13. The system of claim 1, wherein the user-selectable switch comprises a finger-swipe user interface input.

14. A method for aiding a user with creating machine displayable content for a data feed published to an account associated with the user, comprising:
presenting on a user-interface a question and two choices as user-selectable answers for the respective question, and presenting a user-selectable switch for selecting one of the two choices;
monitoring the user-selectable switch to detect a signal representative of a choice selection by the user, and for selecting a template representing a format for media content and generating, in response to the choice selection, computer code for directing the creation of a computer readable media message capable of displaying the choice selection and having the format associated with the template; and
interpreting the computer readable media message to publish the media message as machine displayable content appearing as part of the data feed published within the account associated with the user.

15. The method of claim 14, further comprising
identifying patterns within the data set that are associated with a list of predetermined themes having one of two possible outcomes and generating a headline signal representative of a machine displayable string of text and being associated with an identified pattern.

16. The method of claim 15, further comprising
selecting a premise string representative of a string of text associated with an identified pattern and altering sections of the premise string to include a string of event data associated with at least one of a player, game, and team associated with the identified pattern, and altering the premise string of text to include a string of even data.

17. The system of claim 15, further comprising
prioritizing the themes to rank the themes identified by the publisher processor into a ranked list of prioritized themes, and selecting based on the rank, which theme to publish to the users.

18. The method of claim 15, further comprising
generating a user statement by replacing the headline signal with a user statement string representative of a machine displayable string of text setting out the user choice selection.

19. The method of claim 13, further comprising
monitoring the user's activity within the user account and creating a network of relationships, wherein the relationship is representative of an association between the user and a second user of the system and wherein the association is determined based on monitoring the choices selected by the user.

20. The method of claim 19, further comprising
processing the network of relationships to identify activities associated with the users in the network of relationships to generate content as a function of identified activities to add to the media message.
